(19) United States
(12) Patent Application Publication
(10) Pub. No.: US 2015/0328660 A1
(43) Pub. Date: Nov. 19, 2015

(54) PRETREATMENT METHOD AND SYSTEM FOR APPLICATION OF COATING TO SHOE PARTS

(71) Applicant: ORISOL ASIA LTD., Tortola (VG)

(72) Inventors: Chun-Yuan CHEN, Chang Hwa (TW); I-Lin LIN, Chang Hwa (TW)

(73) Assignee: ORISOL ASIA LTD., Tortola (VG)

(21) Appl. No.: 14/275,883

(22) Filed: May 13, 2014

(51) Int. Cl. B05D 3/00; A43B 1/10

(52) U.S. Cl. CPC B05D 3/002; A43B 1/10

(57) ABSTRACT

A pretreatment method for application of coating to shoe parts is capable of replacing the conventional primer coating process with the UV radiation process. The coating pretreatment to the shoe parts can be carried out continuously in an automatic manner. Besides, creating etching effect by using UV-C radiation and ozone activating improves the bonding of the shoe parts to the adhesives, without substantial increase in equipment cost. A pretreatment system for application of coating to shoe parts can be provided with more reaction chambers for UV-C radiation and cleaning, so as to increase the breadth of application of the UV radiation system. Subjecting the surface of the shoe parts to UV-C radiation and cleaning process more than one time can activate the surface, and improve the follow-up coating quality.

### BACKGROUND OF THE INVENTION

1. Field of the Invention

The present invention relates to a pretreatment method and system for application of coating to shoe parts, and more particularly to a pretreatment method and system for application of coating to shoe parts, which are capable of replacing the conventional primer coating process with the UV radiation process.

2. Description of the Prior Art

Pretreatment primer for rubber has found wide application due to the fact that the delamination agent on the rubber surface is very hard to remove on the rubber surface and will cause a very bad bonding to Rubber and other materials. Also due to the physical restriction of the chemical mixing, it's very hard to use water based solvent to replace this kind of primer. However, if using solvent based primer might cause healthy problem to worker and not good for earth sustentation.

The conventional application of adhesive coating pretreatment to shoe parts, as shown in FIG. 1, is carried out between a punching process S11 and a coating process S15, and generally comprises the steps of: a cleaning process S12 which involves alkaline cleaning S121, water cleaning S122 and/or acid cleaning S123 to do cleaning of the shoe parts; a process S13 of sending the shoe parts to a stock fitting line by manual; and a primer coating process S14 to apply primer to the shoe parts, the primer coating process S14 further includes a heating process S141 to dry the primer. After that, the coating process S15 which also includes a heating process S151 is carried out, and finally the shoe parts are glued to the shoe by being subjected to a gluing process S16.

If the shoe parts are made of rubber, as shown in FIG. 2, the application of adhesive coating to the shoe parts comprises: cleaning process S21, primer coating S22, heating process S221, gluing and coating process S23, heating process S231, coating S24, heating S241 and gluing process S25. A polishing process S26 can be selectively performed between the primer coating S22 and the heating process S221. If the shoe parts are made of EVA, as shown in FIG. 3, the steps of its adhesive coating process S31-S35 are most the same as the steps S21-S25 of the rubber-made shoe parts. However, it has to improve adhesion by providing functional groups in a grafted way due to high resistance of EVA to environment, which means an adhesion-increasing process S322 by UVA radiation and functional groups grafting should be carried out between the heating process S321 of the primer coating S32 and the gluing and primer coating S33.

It is obvious from the above description that UV radiation has found wide application in shoe industry. It is to be noted that, unlike the conventional application of adhesive coating to the shoe parts simply by washing the shoe parts before UV radiation or directly by UV radiation, the shoe parts made of rubber or TPU must be subjected to etching or grafting process with specialty chemicals to improve adhesion. Therefore, a large number of pretreatment processes are inevitable, which will produce volatile chemicals which are harmful to environment and human beings.

Furthermore, the conventional application of adhesive coating pretreatment to shoe parts still involves manual labor, and therefore is low efficiency.

The present invention has arisen to mitigate and/or obviate the afore-described disadvantages.

### SUMMARY OF THE INVENTION

The primary objective of the present invention is to provide a pretreatment method for application of coating to shoe parts, which is capable of replacing the conventional primer coating process with the UV radiation process. The coating pretreatment to the shoe parts can be carried out continuously in an automatic manner. Besides, creating etching effect by using UV-C radiation and ozone activating can truly improve the bonding of the shoe parts to the adhesives, without substantial increase in equipment cost.

To achieve the above objective, a pretreatment method for application of coating to shoe parts in accordance with the present invention is carried out between a punching process and a coating process, and comprises the following steps: preparing a shoe part; transporting the shoe part with a transport means to a first chamber in which being disposed with UV lights, subjecting a surface of the shoe part to ozone activating and etching by radiating it with UV-C rays; transporting the shoe part with the transport means to a second chamber in which being disposed a cleaning device, removing micro substances from the surface of the shoe part by cleaning it with the cleaning device; transporting the shoe part with the transport means to a third chamber which is functionally the same as the first chamber, subjecting the surface of the shoe part to ozone activating and etching by radiating it with UV-C rays again; and selectively transporting the shoe part with the transport means to a fourth chamber which is functionally the same as the second chamber, and cleaning it for the second time.

Another objective of the present invention is to provide a pretreatment system for application of coating to shoe parts, wherein the UV radiation system of the present invention can be provided with more reaction chambers for UV-C radiation and cleaning, so as to increase the breadth of application of the UV radiation system. Subjecting the surface of the shoe parts to UV-C radiation and cleaning process more than one time can activate the surface, and improve the follow-up coating quality.

To achieve the above objective, an UV radiation system applied to do coating pretreatment to the rubber-made shoe parts by using the pretreatment method in accordance with the present invention comprises: the transport means for transporting the shoe parts; the first chamber provided on the transport means, in the first chamber being provided UV lights for producing 30-80 ppm ozone by radiating the shoe parts with UV-C rays, at a top of the first chamber being defined a vent for discharging ozone; the second chamber being connected to the first chamber, and in the second chamber being disposed a cleaning device and cleaning liquid; the third chamber being located behind and connected to the second chamber, in the third chamber being provided UV lights for producing 30-80 ppm ozone by radiating the shoe parts with UV-C rays, at a top of the third chamber being defined a vent for discharging ozone; the shoe part being transported by the transport means, subjecting the surface of the shoe part to ozone activating and etching by radiating it with UV-C rays in the first chamber, removing micro substances from the surface of the shoe part by cleaning it with the cleaning device in the second chamber, and subjecting the surface of the shoe part to ozone activating and etching by radiating it with UV-C rays again in the third chamber.

### BRIEF DESCRIPTION OF THE DRAWINGS

FIG. 1 is a flow chart showing the conventional method of applying adhesive coating pretreatment to shoe parts;

FIG. 2 is a flow chart showing a conventional pretreatment method for application of coating to rubber-made shoe parts;

FIG. 3 is a flow chart showing a conventional pretreatment method for application of coating to EVA-made shoe parts;

FIG. 4 is a flow chart showing a pretreatment method for application of coating to shoe parts in accordance with the present invention:

FIG. 5 is a flow chart showing a pretreatment method for application of coating to rubber shoe parts in accordance with the present invention:

FIG. 6 is a perspective view of a pretreatment system for application of coating to shoe parts in accordance with the present invention;

FIG. 7 illustrates that the surface of the shoe parts of the present invention is subjected to UV radiation and ozone activating process;

FIG. 8A is a microscope view showing that the rubber has a very smooth surface before reacting with ozone; and

FIG. 8B is microscope view showing that the surface of the rubber has become a roughened one after the rubber reacted with ozone.

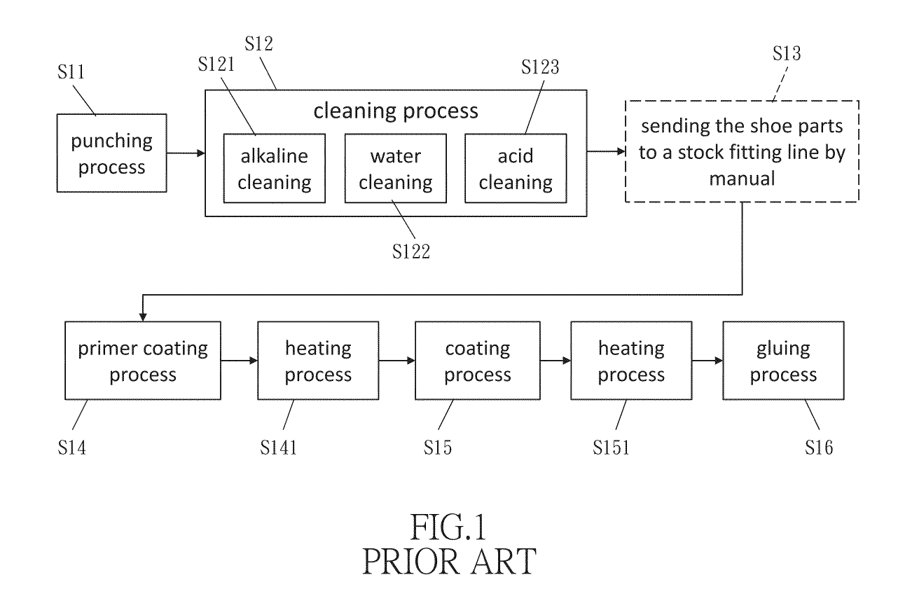

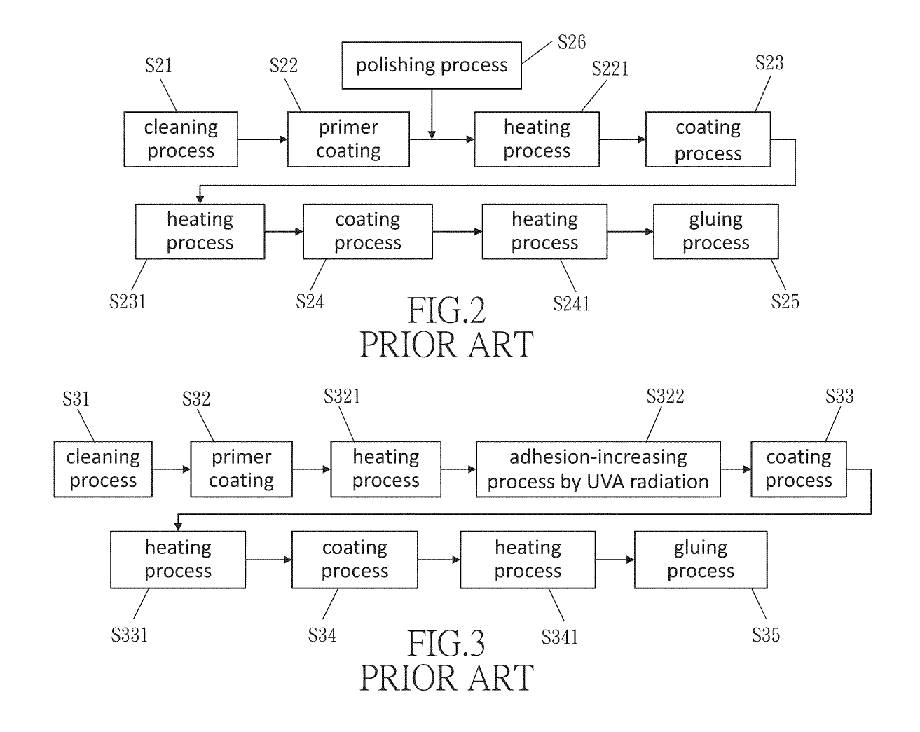

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

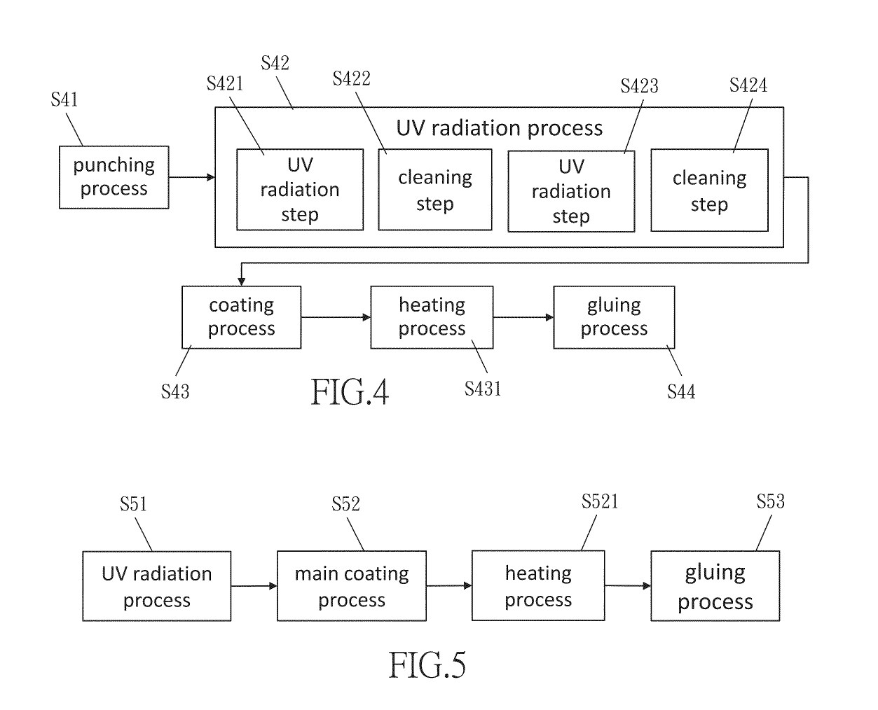

Referring to FIGS. 4-8, the present invention provides a pretreatment method and system for application of coating to shoe parts.

As shown in FIG. 4, the pretreatment method for application of coating to shoe parts in accordance with the present invention is to carry out a UV radiation process S42 which is performed during the shoe manufacturing process before a punching process S41 which produces shoe parts 6 with specific shapes, size and color, and a coating process S43 which is used to apply coating to the shoe parts 6. The UV radiation process S42 involves a UV radiation step S421 and a cleaning step S422. A further UV radiation step S423 and a cleaning step S424 can be performed by repeating the previous steps, or simply by repeating the UV radiation step S423, based on the material property of the shoe parts 6.

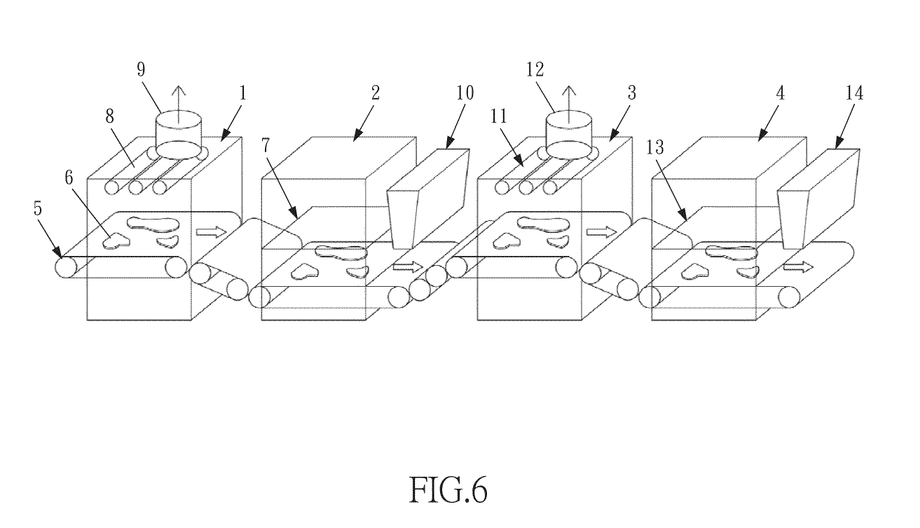

Referring then to FIG. 6, the pretreatment system for application of coating to the shoe part in accordance with the present invention comprises: a transport means 5 for transporting the shoe parts 6, and four reaction chambers formed in the transport means 5, which are a first chamber 1, a second chamber 2, a third chamber 3, and a fourth chamber 4.

In the first chamber 1 are provided UV lights 8 for radiating the shoe parts 6 by UV-C rays at energy density of 2.0-5.0 J/cm, so as to produce 30-80 ppm ozone. On the top of the first chamber 1 is defined a vent 9 for safely discharging ozone. In this embodiment, the UV lights 8 are lamp tubes, preferably 10-46 lamp tubes, and the UV lights can also take other forms.

The second chamber 2 is connected to the first chamber, and in the second chamber 2 is disposed a cleaning device, which is an ultrasonic cleaner in this embodiment, and provides ultrasonic waves to a cleaning liquid 7 stored in the second chamber. Shoe parts 6 are then immersed in the cleaning liquid 7 to wash micro substances off the surface of the shoe parts 6, such as silicon oil. The cleaning device can also be Ion fan or atmospheric plasma cleaning machine. At the exit of the second chamber 2 is provided a drying apparatus, which comprises an air knife (not shown) for producing narrow and strong air flow, and a plurality of NIR (near-infrared) heating lamps (not shown), so that most part of the cleaning liquid residues can be removed from the shoe parts 6.

The third chamber 3 is located behind and connected to the second chamber 2 and structurally and functionally the same as the first chamber. In the third chamber 3 are disposed UV lights 11 for emitting UV-C lights, and at the top of the third chamber 3 is defined an exit 12 for discharging ozone. Setting up the third chamber 3 is aimed at activating again the surface of the shoe parts 6 for a better reaction, so as to improve the follow-up coating quality.

The fourth chamber 4 is functionally and structurally the same as the second chamber 2, and can be selectively connected to the third chamber 3. In the fourth chamber 4 are stored cleaning liquid 13 and an ultrasonic cleaning device which are used to remove micro substances from the surface of the shoe parts 6. In this embodiment, the cleaning liquid 13 in the fourth chamber 4 and the cleaning liquid 7 in the second chamber 2 have the same chemical composition. Or, the cleaning liquid 13 in the fourth chamber 4 may have different chemical composition with respect to the cleaning liquid 7 in the second chamber 2 based on the material property of the shoe parts 6. More specifically, the cleaning liquid can be removed from the second chamber 2 or sulfur-containing molecules can be used to improve cleaning performance. At the exit of the fourth chamber 4 is disposed a drying apparatus 14 which comprises an air knife (not shown) for producing narrow and strong air flow, and a plurality of NIR heating lamps (not shown), so that most part of the cleaning liquid residues can be removed from the shoe parts 6.

With the aforementioned UV radiation system, the present invention provides a pretreatment method for application of coating to shoe parts by UV radiation and then cleaning, the pretreatment method comprises the following steps:

Preparing a molded shoe part 6 which is made of rubber, EVA, PU or TPU;

Transporting the shoe part 6 with a transport means 5 to a first chamber 1 in which being disposed with UV lights, subjecting the surface of the shoe part 6 to ozone activating and etching by radiating it with UV-C rays with a wavelength of 200-280 nm;

Transporting the shoe part 6 with the transport means 5 to a second chamber 2 in which being disposed a cleaning device, removing micro substances from the surface of the shoe part 6 by cleaning it with the cleaning device;

Transporting the shoe part 6 with the transport means 5 to a third chamber 3 which is functionally the same as the first chamber 1, subjecting the surface of the shoe part 6 to ozone activating and etching by radiating it with UV-C rays again; and

Selectively transporting the shoe part 6 with the transport means 5 to a fourth chamber 4 which is functionally the same as the second chamber 2, and cleaning it for the second time.

The speed of the transport means 5 is set to ensure that the shoe part 6 stays long enough in the first chamber 1 for a better reaction with ozone and UV-C rays.

As shown in FIG. 5, when the present invention is applied to do coating pretreatment to the rubber-made shoe parts 6, it only needs to perform a UV radiation process S51 which is automatically carried out by the aforementioned UV radiation system, then a main coating process S52 which further involves a heating process S521 is performed directly after the UV radiation process S51, and finally a gluing process S53 is carried out. As compared to the conventional coating pretreatment, the present invention is much simplified by replacing the conventional primer coating process with the UV radiation process S51.

What described above are the embodiment of the pretreatment method for application of coating to shoe parts in accordance with the present invention and the UV radiation system. As for function and effects of the UV radiation system of the present invention, reference had to the following description.

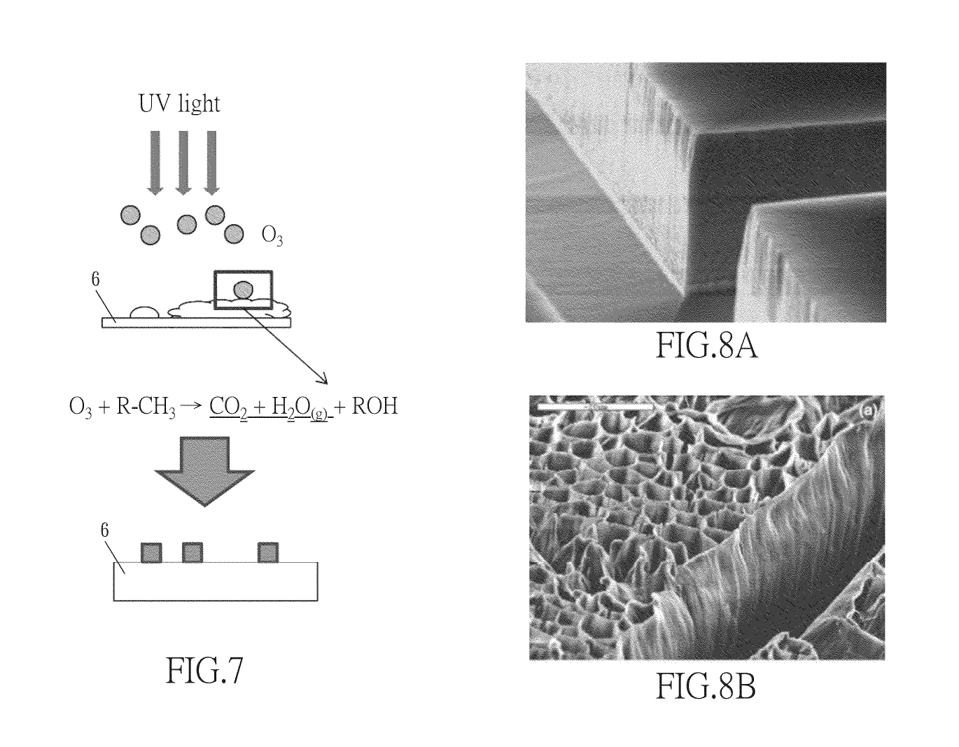

As shown in FIG. 7, which illustrates that the surface of the shoe parts is subjected to UV radiation and ozone activating process, wherein UV-C rays provide energy to oxygen molecules, then the oxygen molecules are split into oxygen atoms, which are finally converted into ozone, and this is a widely used technology for producing ozone. By taking advantage of the properties of the ozone, which are strong reactivity and easy to split, when ozone comes into contact with the surface of the shoe parts 6, UV radiation provides enough energy to break the materials' bonding structure of the shoe parts 6, releases free functional groups, and creates an etching effect on the surface of the shoe parts 6. As a result, the etched surface of the shoe parts 6 will have an improved bonding ability to adhesive. More specifically, using cleaning liquid which is in line with Le Chatelier's principle during cleaning process facilitates the release of more free functional groups. In this embodiment, the cleaning liquids 7 and 13 can be cleaning agent and/or water, acidic solution, an alkaline solution or buffer solution.

FIGS. 7, 8A and 8B shows that R—CH₃ is broken by ozone, after the rubber-made shoe parts 6 is reacted with ozone, and then converted into free hydroxyl functional groups (—OH). FIG. 8A is a microscope view showing that the rubber has a very smooth surface before reacting with ozone, and FIG. 8B is microscope view showing that the surface of the rubber has become a roughened one after the rubber reacted with ozone. Based on Le Chatelier's principle, decreasing the pH value of the environment where the rubber-made shoe parts 6 are placed contributes to the release of more free hydroxyl functional groups (—OH), thus improving the etching effects. Preferably, using H₂SO₄ as cleaning liquid facilitates the production of more carboxyl (—COO) and carbonyl groups on the suface of the rubber-made shoe parts 6, thus considerably improving the bonding of the shoe parts 6 to adhesives.

The following tables 1-3 present the experimental results which the bonding performances of the shoe parts 6 to adhesives. The experiments are conducted by the following steps: placing the shoe parts 6 in a first chamber 1 and radiating it with 2.0-5.0 J/cm UV-C rays, thus producing 30-80 ppm ozone; moving the shoe parts 6 to a second chamber 2 and cleaning it with cleaning liquid, water and ultrasonic waves; moving the shoe parts 6 to a third chamber and radiating it with 2.0-5.0 J/cm UV-C rays, thus producing 30-80 ppm ozone; finally moving the shoe parts 6 to a fourth chamber 4 and cleaning it with clean water and ultrasonic waves to get the results of room temperature pulling test, washing and pulling test, and hydrolysis and pulling test of the shoe parts, as follows:

TABLE 1
room temperature pulling test

| | Average | | | | | | | | |
|---|---|---|---|---|---|---|---|---|---|
| area | value | 1 | 2 | 3 | 4 | 5 | 6 | 7 | 8 |
| Front | 84.4 | 91 | 89 | 89 | 71 | 72 | 97 | — | — |
| portion | | | | | | | | | |
| Middle | 69.1 | 69 | 66 | 73 | 76 | 44 | 73 | 83 | — |
| portion | | | | | | | | | |
| Heel | 80.5 | 74 | 91 | 89 | 88 | 79 | 68 | 68 | 87 |
| portion | | | | | | | | | |

TABLE 2
washing and pulling test

| Front | Average | | | | | | | | |
|---|---|---|---|---|---|---|---|---|---|
| portion | value | 1 | 2 | 3 | 4 | 5 | 6 | 7 | 8 |
| Middle | 46.6 | 41 | 47 | 50 | 52 | 43 | — | — | — |
| portion | | | | | | | | | |
| Heel | 44.3 | 55 | 49 | 47 | 36 | 44 | 38 | 41 | — |
| portion | | | | | | | | | |
| Front | 50.6 | 54 | 51 | 60 | 54 | 49 | 50 | 40 | 47 |
| portion | | | | | | | | | |

TABLE 3
hydrolysis and pulling test

| Front | Average | | | | | | | | |
|---|---|---|---|---|---|---|---|---|---|
| portion | value | 1 | 2 | 3 | 4 | 5 | 6 | 7 | 8 |
| Middle | 44.5 | 47 | 51 | 47 | 37 | 47 | 38 | — | — |
| portion | | | | | | | | | |
| Heel | 31.7 | 42 | 37 | 29 | 27 | 26 | 20 | 41 | — |
| portion | | | | | | | | | |
| Front | 38.9 | 26 | 29 | 46 | 49 | 44 | 37 | 41 | — |
| portion | | | | | | | | | |

It is obvious from the above description that, with the pretreatment method for application of coating to shoe parts and the UV radiation system in accordance with the present invention, the coating pretreatment to the shoe parts can be carried out continuously in an automatic manner. Besides, creating etching effect by using UV-C radiation and ozone activating can truly improve the bonding of the shoe parts to the adhesives, without substantial increase in equipment cost. For different shoe parts 6 with different material properties, the UV radiation system of the present invention can be provided with more reaction chambers for UV-C radiation and cleaning, so as to increase the breadth of application of the UV radiation system. Subjecting the surface of the shoe parts 6 to UV-C radiation and cleaning process more than one time can activate the surface, and improve the follow-up coating quality.

While we have shown and described various embodiments in accordance with the present invention, it is clear to those skilled in the art that further embodiments may be made without departing from the scope of the present invention.

1. A pretreatment method for application of coating to shoe parts being carried out between a punching process and a coating process, and comprising the following steps:
preparing a shoe part;
transporting the shoe part with a transport means to a first chamber in which being disposed with UV lights, subjecting a surface of the shoe part to ozone activating and etching by radiating it with UV-C rays;
transporting the shoe part with the transport means to a second chamber in which being disposed a cleaning device, removing micro substances from the surface of the shoe part by cleaning it with the cleaning device;
transporting the shoe part with the transport means to a third chamber which is functionally the same as the first chamber, subjecting the surface of the shoe part to ozone activating and etching by radiating it with UV-C rays again; and
selectively transporting the shoe part with the transport means to a fourth chamber which is functionally the same as the second chamber, and cleaning it for the second time.

2. The pretreatment method for application of coating to shoe parts as claimed in claim 1, wherein the shoe part is made of rubber, EVA, PU or TPU.

3. The pretreatment method for application of coating to shoe parts as claimed in claim 1, wherein the cleaning device is an ultrasonic cleaner which provides ultrasonic waves to the cleaning liquid stored in the second chamber, to remove micro substances from the surface of the shoe part.

4. The pretreatment method for application of coating to shoe parts as claimed in claim 3, wherein the fourth chamber is connected to the third chamber and provided with a cleaning device which is the same as the cleaning device of the second chamber, the cleaning device of the fourth chamber is an ultrasonic cleaner which provides ultrasonic waves to cleaning liquid stored in the fourth chamber, to remove micro substances from the surface of the shoe part, the cleaning liquid in the fourth chamber and the cleaning liquid in the second chamber have the same chemical composition, or, the cleaning liquid in the fourth chamber has different chemical composition with respect to the cleaning liquid in the second chamber based on material property of the shoe parts.

5. The pretreatment method for application of coating to shoe parts as claimed in claim 3, wherein the cleaning liquids is cleaning agent or water.

6. The pretreatment method for application of coating to shoe parts as claimed in claim 4, wherein the cleaning liquid is cleaning agent or water.

7. The pretreatment method for application of coating to shoe parts as claimed in claim 3, wherein the cleaning liquid is acidic solution, alkaline solution or buffer solution.

8. The pretreatment method for application of coating to shoe parts as claimed in claim 4, wherein the cleaning liquid is acidic solution, alkaline solution or buffer solution.

9. The pretreatment method for application of coating to shoe parts as claimed in claim 1, wherein a speed of the transport means is set to ensure that the shoe part stays long enough in the first chamber for a better reaction with ozone and UV-C rays.

10. The pretreatment method for application of coating to shoe parts as claimed in claim 1, wherein a drying apparatus is disposed at an exit of the second chamber or at an exit of any chamber which is functionally the same as the second chamber, to remove cleaning liquid residues from the shoe part before the shoe part is moved to next chamber.

11. The pretreatment method for application of coating to shoe parts as claimed in claim 1, wherein plural pairs of chambers which are functionally the same as the first and second chambers are provided on the transport means to make shoe parts with different material properties fully react with ozone, so as to create etching effect.

12. (canceled)

13. (canceled)

14. (canceled)

15. (canceled)

16. (canceled)

17. (canceled)

18. (canceled)

19. (canceled)

20. The pretreatment method for application of coating to shoe parts as claimed in claim 1, wherein the ozone activating is performed with ozone concentration ranging from 30 to 80 ppm.

21. The pretreatment method for application of coating to shoe parts as claimed in claim 11, wherein the ozone has a concentration ranging from 30 to 80 ppm.

22. The pretreatment method for application of coating to shoe parts as claimed in claim 10, wherein the drying apparatus comprises an air knife and a plurality of near infrared hearing lamps which are used to remove cleaning liquid residues from the shoe parts.
